(19) United States
(12) Patent Application Publication
(10) Pub. No.: US 2026/0168631 A1
(43) Pub. Date: Jun. 18, 2026

(54) PLUG-IN TUBE LAMP

(71) Applicant: Ledvance Lighting Co., Ltd., Foshan (CN)

(72) Inventors: Zhaomin MAI, Foshan (CN); Yazhen SUN, Foshan (CN); Feipeng SHU, Foshan (CN)

(73) Assignee: Ledvance Lighting Co., Ltd., Foshan (CN)

(21) Appl. No.: 19/531,741

(22) Filed: Feb. 6, 2026

(30) Foreign Application Priority Data
Dec. 5, 2025 (CN) 202522590724.2

(51) Int. Cl. F21K 9/238

(52) U.S. Cl. CPC F21K 9/238

(57) ABSTRACT

The present invention discloses a plug-in tube lamp, wherein power supply lines of multiple light source boards are integrated in a connecting board, all connection paths are concentrated within the connecting board. This avoids redundant and tangled wiring, resolving the disordered cabling inherent in conventional multi-light designs. Removing external wires reduces conductor wear and poor contact, lowering short-circuit risk. Standardized plug-in mating between pin and female headers forms a stable electrical interface, avoiding wire routing and soldering, and enabling rapid assembly—enhancing production efficiency and reducing labor costs. The connecting board provides rigid mechanical support to avoid connecting loosening caused by pulling or vibration ensuring long-term reliability. Moreover, the number of pin header groups is adjustable according to the quantity of light source boards to accommodate varying brightness requirements.

### RELATED APPLICATIONS

The present patent document claims the benefit of priority to Patent Application No. Dec. 5, 2025, filed PLUG-IN TUBE LAMP, and entitled “202522590724.2,” the entire contents of each of which are incorporated herein by reference.

### BACKGROUND

### 1. Technical Field

This present invention relates to the technical field of lighting devices, particularly to a plug-in tube lamp.

### 2. Background Information

LED plug-in tube lamp is a tube shape LED lamp connected with power supply in the form of plug-in, wherein the electrical connection between the driving module and the light source board is one of the key links in the assembly process of the product core. The mainstream connection solution in the traditional industry is direct wire connection, which has several significant technical defects in practical engineering applications.

With the rapid evolution of LED plug-in tube lamp products towards multiple light sources, high brightness, and modularity, the inherent limitations of traditional direct wire connection methods have become increasingly prominent. When the lamp product is configured with multiple independent light source units, the required number of connecting wires increases linearly, resulting in redundant and lack of regularity in the internal circuit layout which not only significantly increases the complexity and labor cost of the assembly process, but more importantly, the disorderly wiring is prone to problems such as winding and mechanical wear, which will lead to short circuit faults and pose a significant threat to the safety and long-term reliability of the lamp product. In addition, the disorderly wiring also brings great inconvenience to later maintenance and troubleshooting, making it difficult to meet the strict market demands of modern LED plug-in tube lamp products in terms of assembly convenience, structural stability, and safety performance.

It can be seen that that there remain needs for improvement and enhancement in the prior art.

### BRIEF SUMMARY

In view of the shortcomings of the prior art mentioned above, the purpose of the present invention is to provide a plug-in tube lamp, wherein power supply lines of multiple light source boards are integrated in a connecting board, which effectively avoids wire redundancy and entanglement, thereby solving the problem of disorderly wiring caused by wires connection of multiple light sources in the prior art.

In order to achieve the above objectives, the present invention adopts the following technical solutions:

A plug-in tube lamp comprising a connecting board, a driving board, and multiple light source boards, one end of each of the multiple light source boards is equipped with a female header, and one side of the connecting board is equipped with multiple pin header groups, the multiple pin header groups are connected one-to-one to the female headers on each of the multiple light source boards, the other side of the connecting board is electrically connected to the driving board.

The plug-in tube lamp further comprises a lamp head and a dimming board, the lamp head is equipped with a DIP (Dual In-line Package) switch, both the dimming board and the driving board are installed within the lamp head. The DIP switch is electrically connected to the dimming board, and the dimming board is electrically connected to the driving board.

The plug-in tube lamp further comprises at least a lamp tube and a fixing seat, wherein the multiple light source boards are installed in the lamp tube. one end of the lamp tube is fixedly connected to the fixing seat, and the fixing seat is detachably connected to the lamp head.

In the plug-in tube lamp, one end of the lamp tube penetrates the fixing seat and is in contact with the connecting board located inside the lamp head. The connecting board is located between one end of the lamp tube and the driving board.

The plug-in tube lamp further comprises an end cap, the other end of the lamp tube is fixedly connected to the end cap, and the connecting board is located between the other end of the lamp tube and the end cap.

In the plug-in tube lamp, a plurality of Snap-fit slots are arranged on an outer circumferential surface of the tube lamp fixing seat, and a plurality of Snap-fit blocks are arranged on an inner circumferential surface of the lamp head, wherein the Snap-fit blocks and the Snap-fit slots are configured to be in one-to-one engagement.

In the plug-in tube lamp, the lamp head comprises two limiting seats disposed therein, each limiting seat having a first limiting slot on an opposing side, two sides of the dimming board are received in the respective first limiting slots, the lamp head further comprises limiting blocks mounted on opposite inner walls of the lamp head, each limiting block provided with a second limiting slot on an opposing side, wherein two sides of the driving board are received in the respective second limiting slots.

In the plug-in tube lamp, an electrical connector is arranged on the lamp head, the driving board is electrically connected to the electrical connector, and the electrical connector is configured to realize an electrical connection between the plug-in tube and an external power supply device.

In the plug-in tube lamp, connecting blocks are respectively arranged on both sides of the lamp head, and the connecting blocks are configured to achieve a fixed connection between the plug-in tube and a mounting position of an external power supply device.

In the plug-in tube lamp, the lamp tube is a glass diffusion tube, and a high transparency film is covered inside the glass diffusion tube.

### Beneficial Effects

The present invention provides a plug-in tube lamp, wherein power supply lines of multiple light source boards are integrated in a connecting board, all connection paths are concentrated within the connecting board, which effectively avoids wire redundancy and entanglement, thereby solving the problem of disorderly wiring caused by wires connection of the multiple light sources in the prior art. Furthermore, messy wires are discarded, thus the probability of line wear and poor contact is reduced, which significantly reduces the risk of short circuits. What's more, standardized plug-in mating between pin and female headers forms a stable electrical interface, further reducing the risk of short circuits. In addition, the plug-in connection of pin and female headers obviates the need for tedious wire organization and soldering, allowing the multiple light source board to be quickly docked with the connecting board, effectively improving assembly efficiency and reducing labor costs. The connecting board provides rigid support, avoiding loose connections of wires caused by pulling, and ensuring the reliability of the product for long-term use. In addition, the number of pin header groups can be flexibly set according to the number of light source boards, thus the plug-in tube lamp is of strong compatibility and the ability to meet different brightness requirements.

### BRIEF DESCRIPTION OF THE DRAWINGS

To illustrate the technical solutions in the embodiments of the present invention more clearly, the accompanying drawings required for the description of the embodiments will be briefly introduced below.

FIG. 1 is a schematic structural view of an embodiment of the plug-in tube lamp according to the present invention;

FIG. 2 is a first schematic exploded view of the embodiment of the plug-in tube lamp according to the present invention;

FIG. 3 is a second schematic exploded view of the embodiment of the plug-in tube lamp according to the present invention;

FIG. 4 is an exploded view of another embodiment of the plug-in tube lamp according to the present invention.

The reference numbers correspond as follows:
1. Connecting board, 11. Pin header group, 2. Driving board, 3. Light source board, 31. Female header, 4. Lamp head, 40. Hollow cavity, 41. DIP switch, 42. Snap-fit block, 43. Limiting seat, 431. First limiting slot, 44. Limiting block, 441. Second limiting slot, 45. Electrical connector, 46. Connecting block, 5. Dimming board, 6. Lamp tube, 7. Fixing seat, 71. Snap-fit slot, 8. End cap.

### DETAILED DESCRIPTION OF THE DRAWINGS AND THE PRESENTLY PREFERRED EMBODIMENTS

The present invention provides a plug-in tube lamp. In order to make the purpose, technical solution, and effect of the present invention clearer and more explicit, the invention will be described in more detail below with reference to the accompanying drawings and specific embodiments.

It should be understood that, in the description of the present invention, the terms “inner”, “outer”, and similar directional or positional references are based on the orientations shown in the drawings. These terms are used solely for convenience of description and simplification, and are not intended to limit the scope of the invention. Furthermore, terms such as “install”, “connect”, and the like should be interpreted broadly. The precise meaning of such terms will be readily apparent to those skilled in the art in view of the present disclosure.

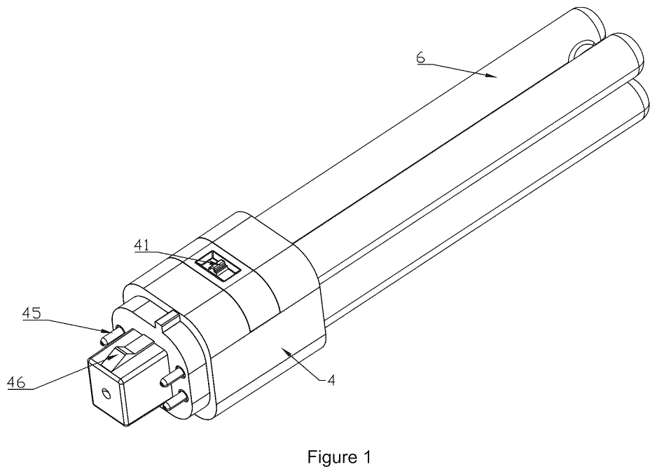

Please refer to FIGS. 1 to 4, the present invention provides a plug-in tube lamp, which comprising a connecting board 1, a driving board 2, and multiple light source boards 3, wherein one end of each of the multiple light source boards 3 is equipped with a female header 31, and one side of the connecting board 1 is equipped with multiple pin header groups 11, the multiple pin header groups 11 are connected one-to-one to the female header 31 on each of the multiple light source boards 3. The other side of the connecting board 1 is electrically connected to the driving board 2.

The present invention discloses a plug-in tube lamp wherein the power supply lines of multiple light source boards 3 are integrated in a connecting board 1, and all connection paths are concentrated inside the connecting board 1, which effectively avoids wire redundancy and entanglement, thereby solving the problem of disorderly wiring caused by wires connection of multiple light sources in the prior art. Furthermore, messy wires are discarded, thus the probability of line wear and poor contact is reduced, which significantly reduces the risk of short circuits. What's more, standardized plug-in mating between pin and female headers forms a stable electrical interface, further reducing the risk of short circuits. In addition, the plug-in connection of pin and female headers 31 obviates the need for tedious wire organization and soldering, allowing the multiple light source board 3 to be quickly docked with the connecting board 1, effectively improving assembly efficiency and reducing labor costs. And the connecting board 1 provides rigid support for the connection, avoiding loose connection of wires caused by pulling, and ensuring the reliability of the product for long-term use. In addition, the number of pin header groups 11 can be flexibly set according to the number of light source boards, thus the plug-in tube lamp is of strong compatibility and the ability to meet product designs with different brightness requirements.

In this embodiment, a same end of each light source board 3 is fixedly connected with a female header 31, which is fixed by welding or integrated with the light source board 3. Pins of the female header 31 are conductive with a circuit of the light source board 3. There are multiple independent pin header groups 11 being integrated and formed on one side of the connecting board 1. Each pin header group 11 is welded and fixed to internal circuit traces of the connecting board 1, and is mechanically fixed and electrically connected to the female header 31 of corresponding light source board 3 through a plug-in cooperation. Once the pin header group 11 is inserted into the female header 31, a tightly fitting conductive connection is formed. The other side of the connecting board 1 is electrically connected to the driving board 2 through wire welding or integrated conductive sheet crimping, in the embodiment, the driving board can be an MP3402 switching regulator. When the driving board 2 is connected to external power, the mains electricity is converted into low-voltage DC power required by the light source board 3. The driving board 2 transmits the converted power to a preset shunt circuit inside the connecting board 1 through the electrical connection with the connecting board 1. The connecting board 1 distributes the converted power to each independent pin header group 11 through the integrated circuit trace inside. Each pin header group 11 transmits the distributed power to each light source board 3 through the conductive connection with the corresponding female header 31 of the light source board 3, driving all light source boards 3 to emit light synchronously, thereby enabling a single-input, multiple-output power supply configuration for multiple light sources. The specific conductive principle among the driving board 2, connecting board 1, and light source board 3 is based on prior art and will not be elaborated here.

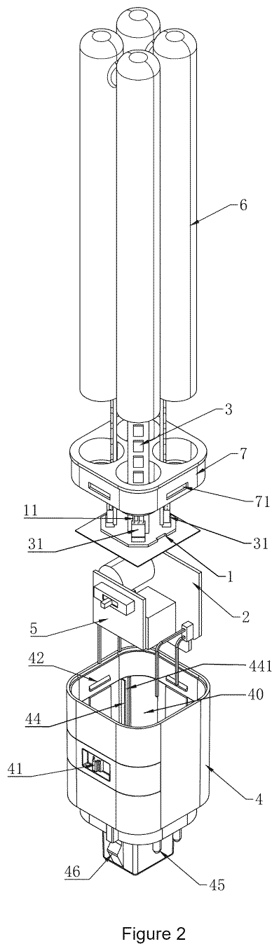

Please refer to FIGS. 1 and 2, the plug-in tube lamp further comprises a lamp head 4 and a dimming board 5, wherein a DIP (Dual In-line Package) switch 41 is arranged on the lamp head 4, both the dimming board 5 and the driving board 2 are installed within the lamp head 4, the DIP switch 41 is electrically connected to the dimming board 5, and the dimming board 5 is electrically connected to the driving board 2.

In this embodiment, a hollow cavity 40 is formed in the lamp head 4, the dimming board 5 and the driving board 2 are both installed inside the hollow cavity 40 of the lamp head 4, and the dimming board 5 and the driving board 2 are arranged in parallel. The DIP switch 41 is fixed to an outer surface of the lamp head 4 through a buckle or screw, and pins of the DIP switch 41 extend into the cavity of the lamp head 4 through a reserved through-hole on the lamp head 4, and are electrically connected to corresponding solder pads on the dimming board 5 through welding. The dimming board 5 is connected to the driving board 2 through wire welding, PCB board conductive terminal docking, or flexible cable connection, ensuring bidirectional conduction of dimming signals and power transmission.

When the user actuates the DIP switch 41 on the outer surface of lamp head 4, a desired brightness level or dimming mode is set. The DIP switch 41 converts a gear signal into an electrical signal, which is transmitted to the dimming board 5 through the electrical connection with the dimming board 5. A dimming control IC is incorporated in the dimming board 5, which is known in the prior art, for example, a BP5758 dimming control IC, that processes a received brightness-level signal and outputs a corresponding control signal. The control signal is transmitted to the driving board 2 through the electrical connection between the dimming board 5 and the driving board 2. The driving board 2 adjusts parameters of the output electrical power according to the control signal, and the adjusted electrical power is transmitted to the light source board 3 through the connecting board 1, achieving precise adjustment of the brightness of the light source, which flexible brightness adjustment allows the plug-in tube lamp to be adapted to various usage scenarios, fulfilling diverse lighting needs and enhancing product usability and user experience.

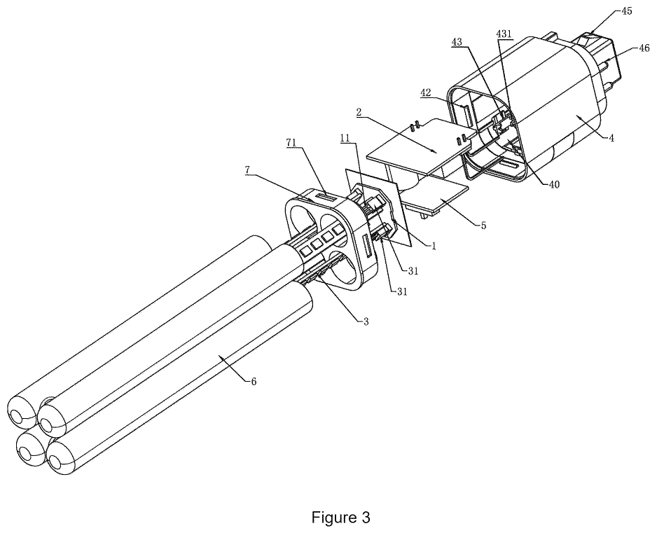

Please refer to FIGS. 2 and 3, the plug-in tube lamp further comprises at least a lamp tube 6 and a fixing seat 7, which forms a lamp tube assembly with the lamp tube 6, wherein the multiple light source boards 3 are installed in the lamp tube 6, and one end of the lamp tube 6 is fixedly connected to the fixing seat 7. The fixing seat 7 is detachably connected to the lamp head 4.

In this embodiment, multiple light source boards 3 are uniformly distributed and installed inside an inner cavity of the lamp tube 6 through adhesive bonding, and light-emitting surfaces of the multiple light source boards 3 face towards outside of the lamp tube 6 to ensure effective light transmission. The end of the lamp tube 6 adjacent to the lamp head 4 is fixed to the fixing seat 7 in an interference fit method, ensuring tight contact between the end of the lamp tube 6 and a connection surface of the fixing seat 7. Furthermore, an end of the fixing seat 7 away from the lamp 6 is detachably connected to the lamp head 4, achieving modular docking between the lamp head 4 and the lamp tube assembly.

The lamp tube 6, as a packaging and protective carrier for the light source board 3, not only provides physical protection for the light source board 3, blocks impurities such as dust and water vapor from contacting the light source board 3 to extend its service life, but also achieves light diffusion and transmission, reduces light scattering loss, and improves lighting efficiency. The fixing seat 7 serves as an intermediate connecting component, providing installation reference for the lamp tube 6 and limiting its radial and axial displacement. On the other hand, the fixing seat 7 provides an interface for the connection between the lamp head 4 and the lamp tube assembly, ensuring precise alignment of the electrical connections among the driving board 2, connecting board 1, and light source board 3. Furthermore, once the multiple light source boards 3 are fixed within the lamp tube 6, an integrated lamp tube assembly is formed, which effectively suppresses vibration during transportation or operation, ensuring consistent light emission. Meanwhile, the connection between the fixing seat 7 and the lamp head 4, enables rapid mating of the light source assembly with the driving and dimming system to complete overall assembly. The detachable design between the lamp tube assembly and the lamp head 4 allows the lamp tube assembly to be replaced independently in the event of a failure of the light source boards 3, eliminating the need for full-unit replacement and effectively reducing maintenance costs. The light source assembly comprises at least the connecting board 1, the light source board 3, the lamp tube 6 and the fixing seat 7, and the driving and dimming system comprises at least the driving board 2 and the dimming board 5.

Please refer to FIGS. 2 and 3, one end of the lamp tube 6 penetrates the fixing seat 7 and is in contact with the connecting board 1 located inside the lamp head 4. The connecting board 1 is located between one end of the lamp tube 6 and the driving board 2.

In this embodiment, one end of the lamp tube 6 passes through at least a central through-hole of the fixing seat 7, which is a reserved through-hole on the fixing seat 7 to match with an outer diameter of the lamp tube 6. The end of the lamp tube 6 extends into the lamp head 4. The connecting board 1 is located inside the lamp head 4 and between the extended end of the lamp tube 6 and the driving board 2. The three are arranged in an axial sequence, making the electric energy transmission path linear, shortening the current transmission distance, reducing energy loss caused by wire resistance or contact resistance, and thereby improving the utilization rate of electric energy. The connecting board 1 is clamped between the lamp tube 6 and the driving board 2, forming a bidirectional limit, fixing better the position of the connecting board 1, thereby avoiding poor contact caused by displacement or vibration of the connecting board 1, ensuring the stability of the electrical connection, which is especially suitable for frequent insertion and removal or vibration environments.

Please refer to FIGS. 2 and 3, a plurality of Snap-fit slots 71 are arranged on an outer circumferential surface of the tube lamp fixing seat 7, and a plurality of Snap-fit blocks 42 are arranged on an inner circumferential surface of the lamp head 4, wherein the Snap-fit blocks 42 and the Snap-fit slots 71 are configured to be in one-to-one engagement.

In this embodiment, a plurality of Snap-fit slots 71 are uniformly distributed on the outer circumferential surface of the fixing seat 7, and a plurality of Snap-fit blocks 42 are provided at the corresponding positions of the Snap-fit slots 71 on the inner circumferential surface of the lamp head 4. During assembly, the fixing seat 7 is inserted into the cavity of the lamp head 4 along an axial direction of the lamp head 4, and each Snap-fit block 42 slide into a bottom of the corresponding Snap-fit slot 71 along an inclined surface of the Snap-fit slot 71. A limiting surface of the Snap-fit slot 71 mates with a locking surface of the Snap-fit block 42, achieving detachable fixation, whose separation can be accomplished by reverse pulling. The detachable feature of the Snap-fit connection allows for quick separation and docking of the lamp head 4 and the lamp tube assembly, facilitating later maintenance or component replacement.

Please refer to FIGS. 2 and 3, the lamp head 4 comprises two limiting seats 43 disposed therein, each having a first limiting slot 431 on an opposing side, the two sides of the dimming board 5 are received in the respective first limiting slots 431. The plug-in tube lamp further comprises limiting blocks 44 mounted on opposite inner walls of the lamp head 4, each limiting block 44 provided with a second limiting slot 441 on an opposing side, wherein two sides of the driving board 2 are received in the respective second limiting slots 441.

In this embodiment, two opposing limiting seats 43 are disposed within the lamp head 4, and the limiting seats 43 are integrated with the lamp head 4. The first limiting slots 431 are arranged on opposing side surfaces of two limiting seats 43, and are configured to extend axially. The slot width of the first limiting slots 431 matches the thickness of the dimming board 5, which is a gap fit or transition fit. The two side edges of the dimming board 5 are respectively received in the two first limiting slots 431, whereby the radial displacement of the dimming board 5 is limited by the slot walls, and axial positioning is achieved upon full axial insertion. The first limiting slot 431 of the limiting seat 43 provides a precise installation reference for the dimming board 5, ensuring secure fixation of the dimming board 5 within the lamp head 4 which effectively suppresses vibration during transportation or operation.

Two opposing limiting blocks 44 are disposed on inner walls of the lamp head 4, and the limiting blocks 44 are integrated with the lamp head 4. The second limiting slot 441 are arranged on opposing side surfaces of two limiting blocks 44, and are configured to extend axially. The slot width of the second limiting slots 441 matches the thickness of the driving board 2. The two side edges of the driving board 2 are respectively received in the two second limiting slots 441, and the radial and axial fixation of the driving board 2 is achieved by the limiting action of the slot walls. The second limiting slot 441 of the limiting seat 44 provides a precise installation reference for the driving board 2, ensuring accurate alignment of the electrical connection interfaces among the driving board 2, the dimming board 5, and the connecting board 1. This arrangement prevents poor electrical connection due to positional deviation, and effectively suppresses vibration and impact during transportation or operation, thereby avoiding circuit failures caused by loose components.

Please refer to FIGS. 1 to 3, the lamp head 4 is equipped with an electrical connector 45, to which the driving board 2 is electrically connected, and the electrical connector 45 is configured for realizing the electrical connection between the plug-in tube lamp and the external power supply device.

In this embodiment, the electrical connector 45 is a metal conductive pin, fixedly installed at an end of the lamp head 4 away from the lamp tube 6, and fixed to the lamp head 4 by welding, with its internal conductive portion extending into the lamp head 4. Meanwhile, the driving board 2 is fixedly connected to the electrical connector 45 through conductive wires. Furthermore, an external conductive portion of the electrical connector 45 is exposed outside the lamp head 4, and configured to mate with interfaces of an external power supply device, such as standard socket or power terminal block, thereby enabling plug-in connection to the external power supply device. The external power supply device, such as a mains socket or a dedicated power module, supplies electrical power to the electrical connector 45 by mating with its external conductive portion. The electrical connector 45 then transmits the received power to the driving board 2 via its internal conductive portion. Finally, driving board 2 rectifies, filters, and steps down the input power before delivering it to the connecting board 1 and the light source board 3, thereby completing the power supply sequence.

Please refer to FIGS. 1 to 3, the lamp head 4 is equipped with connecting blocks 46 on both sides, which are configured to achieve a fixed connection between the plug-in tube lamp and an mounting position.

In this embodiment, connecting blocks 46 are in block-shaped structure integrally formed with the lamp head 4 and symmetrically arranged on opposite sides thereof to ensure balanced load distribution during installation. Each connecting block 46 is configured as a snap-fit structure adapted to various types of mounting positions, such as lamp brackets, mounting boards, or wall-mounted sockets, thereby broadening the range of applicable installation scenarios. The connecting block 46 could engage with the mounting positions via snap-fit coupling, establishing a secure connection between the entire plug-in tube lamp and the mounting position, which enables rapid installation and reduces user effort.

Preferably, the lamp tube 6 is a glass diffusion tube, which is coated with a high transparency film inside.

In this embodiment, the lamp tube 6 is made of glass material and has a hollow cylindrical body with optical properties of diffusing light. The lamp tube 6 is covered with a high transparency film, which is PET high transparency film or PC high transparency film. It is fixedly attached to an inner wall of the glass diffusion tube through electrostatic adsorption, adhesive bonding or hot-pressing bonding, forming an integrated transparent structure with the glass diffusion tube.

Once the light source board 3 emits light, the light radiates outward in all directions and first strikes on the high transparency film on the inner wall of the lamp tube 6. The high transparency film has a high optical transmittance, thereby minimizing reflective losses and allowing the majority of the light to pass through. The glass diffusion tube further scatters the transmitted light by virtue of its material's diffuse reflection properties, achieving uniform light distribution and preventing the formation of a glaring point source. Ultimately, through the synergistic action of the high transparency film and the glass diffusion tube, light is emitted from the lamp tube 6 in a soft and uniform manner, delivering a comfortable illumination effect that effectively mitigates glare, enhances visual comfort for users, and renders the plug-in tube lamp suitable for a variety of lighting applications, including office, residential, and commercial environments.

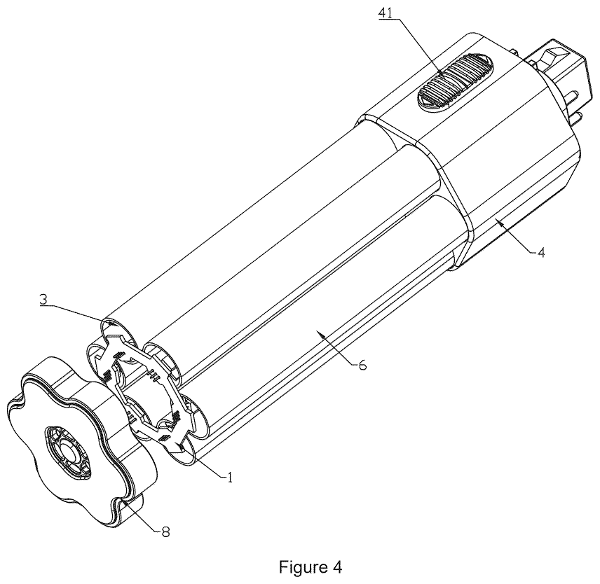

In another embodiment, please refer to FIG. 4, the plug-in tube lamp further comprises an end cap 8, and the other end of the lamp tube 6 is fixedly connected to the end cap 8. The connecting board 1 is located between the other end of the lamp tube 6 and the end cap 8.

In this embodiment, the end cap 8 is configured as an annular structure having an inner diameter matched to the outer diameter of the lamp tube 6, and is fixedly sealed to the end of the lamp tube 6 away from the lamp head 4 by adhesive bonding or interference fit. The connecting board 1 is sandwiched between the other end of the lamp tube 6 and the end cap 8, with the end cap 8 pressing against a peripheral edge of the connecting board 1 to maintain a firm contact between the pin header groups of the connecting board 1 and female headers 31 of the light source board 3. This ensures stable electrical connectivity even under conditions of vibration or thermal cycling. Furthermore, the end cap 8 and the fixing seat 7 provide opposing support to the two ends of the lamp tube 6, thereby enhancing its resistance to bending and impact and reducing the risk of breakage.

It will be understood by those of ordinary skill in the art that various modifications and equivalent substitutions may be made to the present invention based on the disclosed technical solution and inventive concept, and that all such modifications and substitutions fall within the scope of protection of the present invention.

1. A plug-in tube lamp, comprising a connecting board, a driving board, and multiple light source boards, wherein one end of each of the multiple light source boards is equipped with a female header, one side of the connecting board is equipped with multiple pin header groups, the multiple pin header groups are connected one-to-one to the female headers on each of the multiple light source boards, and the other side of the connecting board is electrically connected to the driving board.

2. The plug-in tube lamp according to claim 1, wherein a same end of each light source board is fixedly connected with the female header, which is fixed by welding or integrated with the light source board,
there are multiple independent pin header groups being integrated and formed on one side of the connecting board, the other side of the connecting board is electrically connected to the driving board through wire welding or integrated conductive sheet crimping.

3. The plug-in tube lamp according to claim 1, further comprises a lamp head and a dimming board, wherein the lamp head is equipped with a DIP (Dual In-line Package) switch, both the dimming board and the driving board are installed within the lamp head, the DIP switch is electrically connected to the dimming board, and the dimming board is electrically connected to the driving board.

4. The plug-in tube lamp according to claim 3, wherein the lamp head is of a hollow cavity structure, the dimming board and the driving board are arranged in parallel in the lamp head, the DIP switch is fixed to an outer surface of the lamp head.

5. The plug-in tube lamp according to claim 3, further comprises at least a lamp tube and a fixing seat, wherein the multiple light source boards are installed in the lamp tube, one end of the lamp tube is fixedly connected to the fixing seat, and the fixing seat is detachably connected to the lamp head.

6. The plug-in tube lamp according to claim 5, wherein multiple light source boards are uniformly distributed and installed inside an inner cavity of the lamp tube, and light-emitting surfaces of the multiple light source boards face towards outside of the lamp tube,
one end of the lamp tube adjacent to the lamp head is fixed to the fixing seat in an interference fit method, an end of the fixing seat away from the lamp is detachably connected to the lamp head.

7. The plug-in tube lamp according to claim 5, wherein one end of the lamp tube penetrates the fixing seat and is in contact with the connecting board located inside the lamp head, the connecting board is located between the end of the lamp tube and the driving board.

8. The plug-in tube lamp according to claim 7, wherein the end of the lamp tube passes through at least a central through-hole of the fixing seat, which is a reserved through-hole on the fixing seat to match with an outer diameter of the lamp tube, the end of the lamp tube 6 extends into the lamp head,
the connecting board is located inside the lamp head and between the extended end of the lamp tube and the driving board, the lamp tube, the fixing seat and the lamp head are arranged in an axial sequence,
the connecting board is clamped between the lamp tube and the driving board.

9. The plug-in tube lamp according to claim 5, further comprises an end cap, the other end of the lamp tube is fixedly connected to the end cap, and the connecting board is located between the other end of the lamp tube and the end cap.

10. The plug-in tube lamp according to claim 5, wherein a plurality of Snap-fit slots are arranged on an outer circumferential surface of the tube lamp fixing seat, and a plurality of Snap-fit blocks are arranged on an inner circumferential surface of the lamp head, wherein the Snap-fit blocks and the Snap-fit slots are configured to be in one-to-one engagement.

11. The plug-in tube lamp according to claim 3, wherein the lamp head comprises two limiting seats disposed therein, each limiting seat having a first limiting slot on an opposing side, two sides of the dimming board are received in the respective first limiting slots,
the lamp head further comprises limiting blocks mounted on opposite inner walls of the lamp head, each limiting block provided with a second limiting slot on an opposing side, wherein two sides of the driving board are received in the respective second limiting slots.

12. The plug-in tube lamp according to claim 3, wherein an electrical connector is arranged on the lamp head, the driving board is electrically connected to the electrical connector, and the electrical connector is configured to realize an electrical connection between the plug-in tube lamp and an external power supply device.

13. The plug-in tube lamp according to claim 12, wherein the electrical connector is a metal conductive pin, fixedly installed at an end of the lamp head away from the lamp tube, with internal conductive portion extending into the lamp head, the driving board is fixedly connected to the electrical connector through conductive wires,
an external conductive portion of the electrical connector is exposed outside the lamp head, and configured to mate with interfaces of the external power supply device.

14. The plug-in tube lamp according to claim 3, wherein connecting blocks are respectively arranged on both sides of the lamp head, and the connecting blocks are configured to achieve a fixed connection between the plug-in tube lamp and a mounting position of an external power supply device.

15. The plug-in tube lamp according to claim 14, wherein connecting blocks are in block-shaped structure integrally formed with the lamp head and symmetrically arranged on opposite sides thereof, each connecting block is configured as a snap-fit structure adapted to various types of mounting positions.

16. The plug-in tube lamp according to claim 5, wherein the lamp tube is a glass diffusion tube, and a high transparency film is covered inside the glass diffusion tube.

17. The plug-in tube lamp according to claim 16, wherein the lamp tube is made of glass material and has a hollow cylindrical body with optical properties of diffusing light,
The high transparency film is PET high transparency film or PC high transparency film, which is fixedly attached to an inner wall of the glass diffusion tube.
